(19) United States
(12) Patent Application Publication
(10) Pub. No.: US 2004/0221751 A1
(43) Pub. Date: Nov. 11, 2004

(54) Self-aligning, self-guiding embossing template

(75) Inventor: Robert Arnold, Spokane, WA (US)

Correspondence Address: Robert M. Haroun, SOFER & HAROUN, L.L.P., Suite 910, 317 Madison Avenue, New York, NY, 10017, US

(73) Assignee: Craftek Products, Inc.

(21) Appl. No.: 10/780,328

(22) Filed: Feb. 17, 2004

Related U.S. Application Data
(63) Continuation-in-part of application No. 10/429,911, filed on May 5, 2003.

(51) Int. Cl. B31F 1/07

(52) U.S. Cl. 101/3.1

(57) ABSTRACT

The present invention is directed to an embossing template for embossing design onto a sheet media using an embossing tool. The template maintains an embossing plate, with at least one embossing opening. A tool guide is provided, coupled to the embossing plate. The tool guide has at least one tool guide opening thereon. The tool guide opening corresponds to the embossing opening, such that when the sheet media is inserted between the embossing plate and the tool guide, the embossing tool is moved around the edges of the tool guide opening, pressing the sheet media against the edges of the embossing opening, embossing a design into the sheet media.

### RELATED APPLICATION

This application is a continuation-in-part of U.S. patent application Ser. No. 10/429,911, filed on May 5, 2003, the entirety of which is incorporated herein by reference.

### FIELD OF THE INVENTION

This invention relates to an embossing template. More specifically, this invention relates to an embossing template for manually embossing sheet media.

### BACKGROUND OF THE INVENTION

This invention relates to the use of a guide tool to emboss sheet media. In arts such as paper crafting, scrapbooking, and rubberstamping it is often desirable to emboss decorative designs onto a sheet medium such as paper or card stock. These designs may be used in combination or coordination with other paper crafting effects such as holes or slits produced by various paper punches such as those commonly known as craft punches, corner punches, corner rounders and photo mounting punches, or with the addition of color or other effects to the embossed designs.

Typically, paper embossing has been done by hobbyists and artists by utilizing a template with openings disposed therein, said openings corresponding to the design that is to be embossed, a light box, and an embossing tool such as the type commonly known as a “ball-tip stylus.” The template is placed upon the lighted surface of the light box and a sheet medium such as paper or light card stock is placed over the template. A non-permanent adhesive means such as removable tape may be used to hold the template in position relative to the paper during the embossing process. The embossing tool is used to press down on the top surface of the sheet medium, forcing it into the openings in the template. The openings are visible through the sheet medium due to light from the light box radiating through the openings in the template and through the sheet medium. The pressure from the tip of the embossing tool causes the sheet medium to be permanently displaced from the nominal plane of the sheet medium, forming the embossed design. This allows embossing of highly intricate designs, however it does requires the use of a light box, which may not be available, convenient, or possible to use in certain environments or situations, such as when traveling. The light box has been required for the user to see the locations of the openings in the template in order to position and move the embossing tool correctly. Also, it is not practical to use a light box for sheet media that is too opaque for the light to penetrate.

The prior art does not provide a satisfactory means for accurately aligning the design to be embossed relative to corners, edges or other features of the sheet medium. Thus, the template must be placed by estimating the desired location of the embossed image, or measuring and placing alignment marks on the surface of the sheet medium. This is tedious, prone to inaccuracies, and, if marks are used, they normally must be erased or otherwise removed before the completion of the project.

U.S. Pat. No. 5,511,472 to Taylor attempts to eliminate the need for a light box by teaching a template comprising two identical sheets hingedly connected along one peripheral edge and between which the sheet medium to be embossed is inserted. The openings in the top sheet of the template are identical to and aligned with the openings in the bottom, and are used as a guide to position and move the embossing tool relative to the openings in the bottom.

The problem with this approach is that the embossing tool does not properly follow fine details of the openings in the lower sheet because it is aligned to the edges of the openings in the upper sheet and is held away from the edges of the openings in the lower sheet by the curvature of the ball-tip. Because the edge of the ball-tip follows the upper guide, it does not firmly press the sheet medium against the lower guide, resulting in a soft edge rather than the desirable sharp edge that is characteristic of embossed designs. Also, the details of the design can be no smaller than the diameter of the ball-tip. This precludes this solution from being useable for all but very simple designs.

Fiskars Brands, Inc. markets a device (Patent Pending in the United States) that partially overcomes one of the shortcomings of '472 patent in that it uses a slightly larger opening for the top guide than for the bottom embossing opening; however, the top openings are a fixed dimension larger than the bottom ones and do not compensate for the need for the top guide edge to go farther from the bottom edge to accommodate certain fine detail. The Fiskars device uses a large, expensive base to hold the upper and lower guide and embossing elements and to provide the work surface upon which the embossing is performed. Also, it is difficult to accurately align the sheet medium to the designs to be embossed because no positive alignment means are provided for the sheet media.

It is the intent of the current invention to overcome these shortcomings of the prior art and to provide other substantial advantages to the user.

### SUMMARY OF THE INVENTION

The present invention is an embossing template for producing decorative embossed shapes or designs on a planar sheet medium such as paper, cardstock, and the like, using an embossing tool, typically of the type known as a ball-tip stylus. The template comprises a lower embossing plate member and an upper tool guide member, fixed in relationship to each other at one or more points such that the medium to be embossed is disposed between them. The embossing tool is used to press the sheet medium into openings disposed in the embossing plate, with the openings corresponding to the design to be embossed into the sheet medium. The pressure of the embossing tool permanently displaces the sheet medium, along the edges of the openings in the embossing plate, from the nominal plane of the sheet medium, producing the embossed design.

Openings are disposed in the tool guide of particular shapes and in relationships to the openings in the embossing plate such that the embossing tool, when inserted into the openings in the tool guide, is properly positioned and guided to accurately emboss the design of the opening in the embossing plate into the sheet medium. The openings in the tool guide are larger than the corresponding openings in the embossing plate, with the edges of the tool guide openings offset from the edges of the corresponding openings in the embossing plate by distances that vary depending on the size of the immediate area of the embossing plate opening relative to the size of the tip of the embossing tool. Said embossing plate and tool guide are bonded at appropriate points to hold them in correct juxtaposition.

An edge guide or guides comprising one or more openings or slits in the tool guide provide a positive alignment means to assist in accurately positioning the embossing template relative to the corner, edge, or other feature of the sheet medium.

The present invention allows for a plurality of sets of openings, used serially by repositioning the template on the sheet medium, to permit complex embossed designs that cannot be created using an embossing template with a single set of openings.

The present invention can be used as a stencil to permit the user to add colors or other special effects to the sheet medium either in combination with the embossing or without the embossing.

The present invention can accommodate designs that may be used in combination and coordination with various decorative and functional paper punches, including those commonly known as craft punches, corner punches, corner rounders, and photo mounting punches.

### BRIEF DESCRIPTION OF THE DRAWINGS

The present invention will be further understood from the following description with reference to the accompanying drawings, in which:

FIG. 1 is a perspective view of sheet medium embossed with designs from a corner design template, in accordance with one embodiment of the present invention;

FIG. 2 is a plan view of a corner design template, in accordance with one embodiment of the present invention;

FIG. 3 is a corner design template, tool guide, in accordance with one embodiment of the present invention;

FIG. 4 is a corner design template, embossing plate, in accordance with one embodiment of the present invention;

FIG. 5 is an isometric view of a corner design template, in accordance with one embodiment of the present invention;

FIG. 6 is an isometric view of a corner design template, showing sheet medium disposed therein and use of embossing tool, in accordance with one embodiment of the present invention;

FIG. 7 is a sectional view showing an edge guide in detail, in accordance with one embodiment of the present invention;

FIG. 8 is a sectional view showing an edge guide in detail with sheet medium disposed therein, in accordance with one embodiment of the present invention;

FIG. 9 is a sectional view showing embossing tool and tool guide offset relative to a large opening in embossing plate, in accordance with one embodiment of the present invention;

FIG. 10 is a sectional view showing embossing tool and tool guide offset relative to a small opening in embossing plate, in accordance with one embodiment of the present invention;

FIG. 11 is an isometric view of an embossed sheet medium with corner and edge design embossed thereon, in accordance with one embodiment of the present invention;

FIG. 12 is a plan view of a corner and edge design template, in accordance with one embodiment of the present invention;

FIG. 13 is a plan view of a corner and edge design template, tool guide, in accordance with one embodiment of the present invention;

FIG. 14 is a plan view of a corner and edge design template, embossing plate, in accordance with one embodiment of the present invention;

FIG. 15 is a plan view of a corner and edge design template, with sheet medium disposed therein for embossing a corner design, in accordance with one embodiment of the present invention;

FIG. 16 is a plan view of a corner and edge design template, showing template positions to emboss each of the four corners, in accordance with one embodiment of the present invention;

FIG. 17 is a plan view of a corner and edge design template, with sheet medium disposed therein for embossing an edge design, in accordance with one embodiment of the present invention;

FIG. 18 is a plan view of a corner and edge design template, showing multiple template positions to emboss edge design, in accordance with one embodiment of the present invention;

FIG. 19, is a partial plan view of an embossed sheet medium with complex embossed design requiring a template with three sets of embossing openings, in accordance with one embodiment of the present invention;

FIG. 20 is a plan view of a multiple design template with three sets of embossing openings, in accordance with one embodiment of the present invention;

FIG. 21 illustrates a multiple design template, in accordance with one embodiment of the present invention;

FIG. 22 is a partial plan view of a sheet medium showing photo mounting punches and photo, in accordance with one embodiment of the present invention;

FIG. 23 is a partial plan view of a sheet medium showing photo mounting punches, embossed design, and photo, in accordance with one embodiment of the present invention;

FIG. 24 is a plan view of a photo mount design template, in accordance with one embodiment of the present invention;

FIG. 25 is a plan view of a sheet medium and positions of photo mount design template to emboss each of the four corners, in accordance with one embodiment of the present invention;

FIG. 26 is a perspective view of a folded notecard sheet medium showing photo mounting punches, embossed design, and photo, in accordance with one embodiment of the present invention;

FIG. 27 is a plan view of a folded notecard photo mount design embossing template, in accordance with one embodiment of the present invention;

FIG. 28 is a plan view of a folded notecard photo mount design embossing template in position on sheet medium to emboss each of the four punch locations, in accordance with one embodiment of the present invention;

FIG. 29 is a flow chart of corner design embossing process, in accordance with one embodiment of the present invention;

FIG. 30 is a flow chart of combination corner and edge design embossing process, in accordance with one embodiment of the present invention;

FIG. 31 is a flow chart of a multiple design embossing process, in accordance with one embodiment of the present invention;

FIG. 32 is a flow chart of embossing process in combination with photo mount punches, in accordance with one embodiment of the present invention; and

FIG. 33 is a flow chart of embossing process in combination with photo mount punches on a folded notecard, in accordance with one embodiment of the present invention.

### DETAILED DESCRIPTION OF THE INVENTION

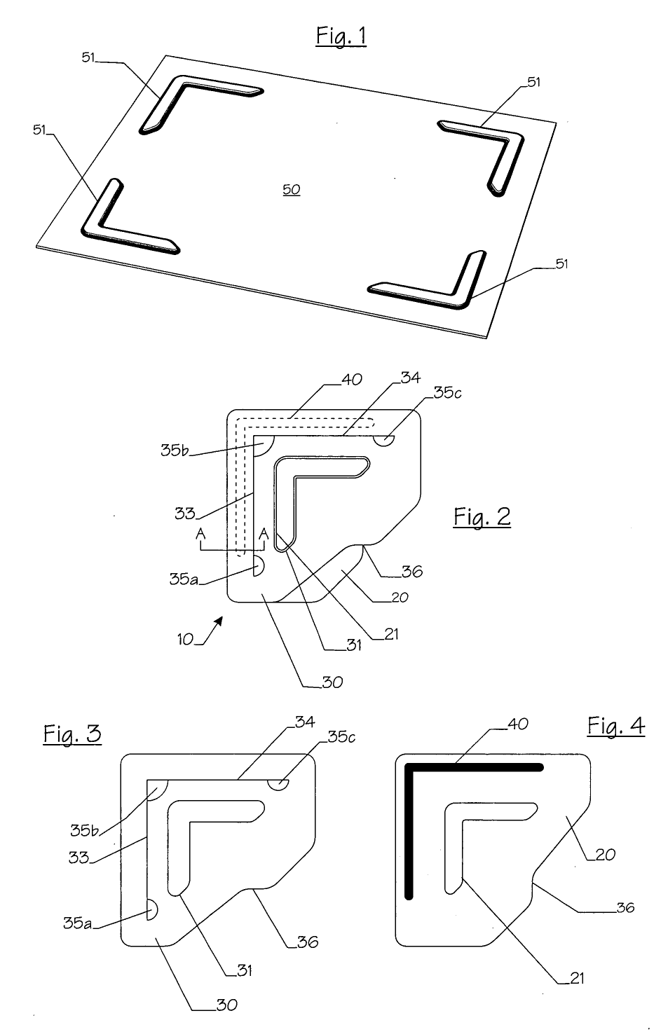

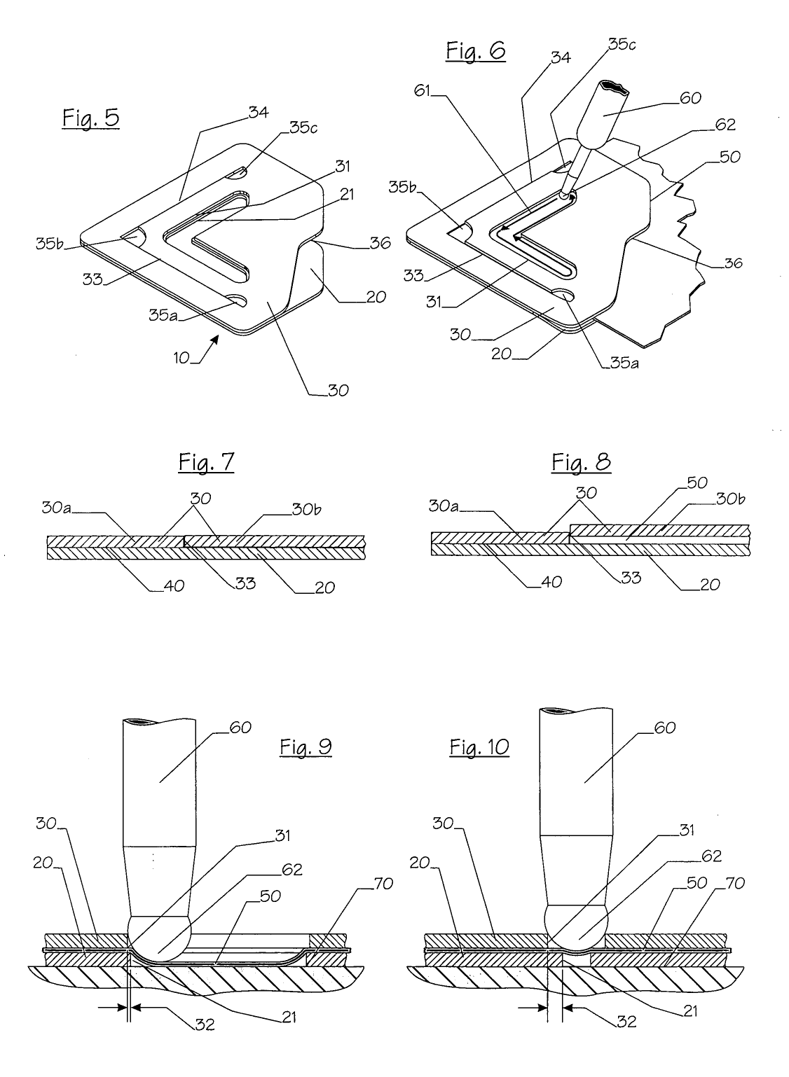

One embodiment of the current invention, intended for embossing designs 51 in the corners of sheet media 50 as illustrated in FIG. 1, is shown in FIGS. 2 through 6. The embossing template 10 comprises an embossing plate 20 with embossing openings 21 corresponding to the designs 51 to be embossed in the sheet medium 50, and a tool guide 30 with tool guide openings 31 corresponding to each embossing opening 21 in the embossing plate 20.

The embossing plate 20 and tool guide 30 may be fabricated from any thin durable material such as sheet plastic or metal and the fabrication method may be any that is capable of producing the amount of detail required for the embossed design. This may include die cutting, laser cutting, engraving, etching, injection molding, or any other method suitable to the materials and design.

The tool guide 30 is attached to the embossing plate 20 by permanently bonding them at bonding area 40. The bonding may be by any means, such as mechanical, chemical, or thermal, suitable to the materials. The bonding area pattern, size, and location may vary from one template design to another depending on the configuration of the templates. The bonding must secure tool guide 20 in correct juxtaposition relative to embossing plate 30 and must maintain the tool guide in close contact to the embossing plate in the area of edge guides 33 and 34 so as to provide an edge to which the edge of sheet medium 50 can be positively aligned.

Referring now to FIG. 6, sheet medium 50 to be embossed is inserted between embossing plate 20 and tool guide 30 at insertion point 36. Depending on the design of template 10, various insertion point designs may be used to facilitate the action of inserting sheet media 50 between the two pieces of the template 10. Sheet medium 50 is inserted until the edges adjacent to the corner of sheet medium 50 contact and align with first and second edge guides, 33 and 34.

Referring now to FIGS. 7 and 8, edge guides 33 and 34 are formed as one or more slits 33 in tool guide 30 forming an outer area 30a, which is bonded to embossing plate 20, and an inner area 30b, which is not bonded to embossing plate 20. When the sheet medium is inserted, it raises inner area 30b of tool guide 30, permitting sheet medium 50 to contact the edge of slit 33 at outer area 30a, which acts as a positive stop for the edge of sheet medium 50.

Referring again to FIG. 6, edge alignment openings 35a, 35b, and 35c, permit the user to visually verify that sheet medium 50 has been full inserted into the template and is flush with both edge guides 33 and 34. The tip 62 of an embossing tool 60, such as the type commonly known as a ball-tip stylus, is inserted into tool guide opening 31. The user applies downward pressure, forcing tip 62 of tool 60 to press sheet medium 50 into the opening in embossing plate 30. Tip 62 of embossing tool 60 is moved around the inner edge of opening 31, following tool path 61, while maintaining downward pressure, forcing sheet medium 50 into embossing plate opening 31, and permanently forming embossed design 51 in sheet medium 50 in the shape of the embossing plate opening 31.

Referring now to FIGS. 9 and 10, the edges of the tool guide openings 31 are offset from the edges of the embossing openings 21 by the distance of a tool guide opening offset 32, to compensate for the curvature of tip 62 of embossing tool 60. As shown in FIG. 9, if the size of opening 21 in the embossing plate 20 is larger than the diameter of tip 62 of embossing tool 60, tip 62 of embossing tool 60 will force sheet medium 50 against working surface 70 upon which embossing template 10 is supported. In this case embossing offset 32 must be relatively small in order to properly position and guide tool tip 62.

As shown in FIG. 10, if the size of opening 21 in embossing plate 20 is smaller than the diameter of tip 62 of embossing tool 60, tip 62 of embossing tool 60 will force sheet medium 50 only partially into opening 21 in embossing plate 20. In this case embossing offset 32 must be relatively large in order to properly position and guide tool tip 62. The dimension of offset 32 will vary depending on the thickness of embossing plate 20 and tool guide 30, the nominal thickness of sheet media 50 for which the template is intended, the diameter of tip 62 of embossing tool 60, and the size of opening 21 at each point in the design.

The size of embossing offset 32 must be determined for each point on each opening 21 in the embossing plate 20 to permit tip 62 of the tool to properly fit the size and shape of opening 21. If the embossing offset 32 is properly sized, the design may be highly detailed with elements of embossed designs that are significantly smaller that the tip diameter of embossing tool 60, even to the point of the edges of the openings 21 meeting at a small acute angle.

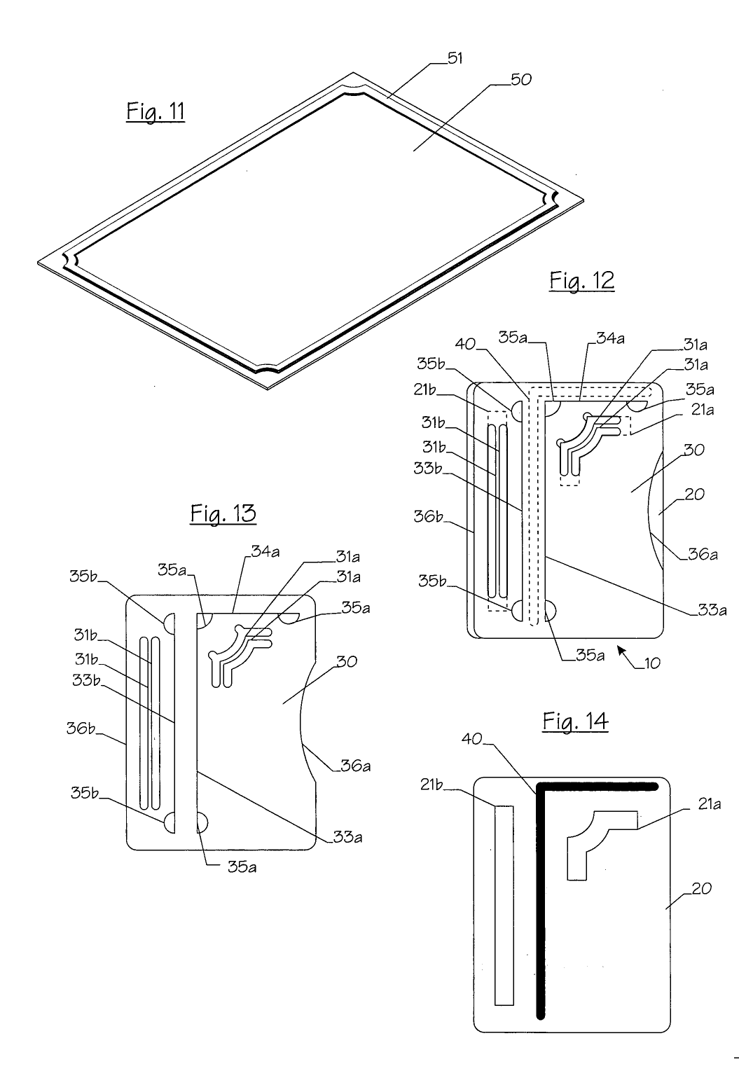

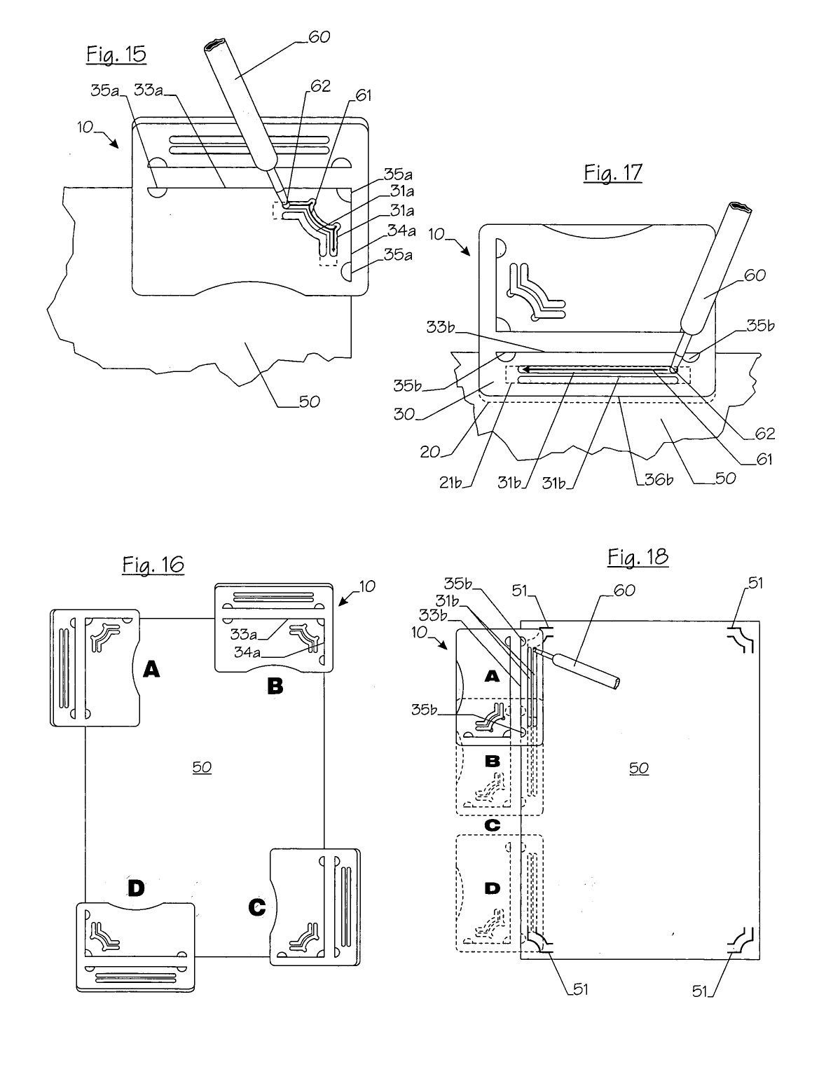

Another embodiment of the current invention, intended for embossing designs 51 in the corners and along the edges of sheet media 50, as illustrated in FIG. 11, is shown in FIGS. 12 through 18. As in the previous embodiment, embossing template 10 comprises an embossing plate 20 and a tool guide 30 bonded together at bonding area 40. All of the elements described in the previous embodiment for embossing corner designs are present in the portion of the current embodiment that is used to emboss corner designs, and are identified as 21a, 31a, 33a, 34a, 35a, and 36a. As shown in FIGS. 15 and 16, this portion of this embodiment is used in the same manner as the previous embodiment. The corner design is positioned at each of corners of the sheet medium 50 aligning the edges adjacent to the corners with first and second edge guides 33a and 34a as shown in FIG. 16. One difference between this and the previous embodiment is the addition of a second set of embossing openings 21b, tool guide openings 31b, an additional edge guide 33b, edge alignment holes 35b, and edge insertion area 36b, all of which are used to emboss a second design along the edge of sheet medium 50.

Referring now to FIG. 17, to emboss a design along an edge of sheet medium 50, sheet medium 50 is disposed between embossing plate 20 and tool guide 30 on the edge design side of template 10 using insertion area 36. Sheet medium 50 is positioned such that its edge abuts edge guide 31b. This can be verified by inspection through edge alignment openings 35b. Template 10 is slidingly positioned along the edge to the desired location. The design is embossed by inserting tip 62 of embossing tool 60 into tool guide opening 31b, pressing sheet medium 50 into embossing plate opening 21 while pressing down tool 60 along tool path 61.

Referring now to FIGS. 15 and 17, this example illustrates an important additional capability of the current invention by which tool guide openings 31a and 31b can limit the motion of tip 62 of embossing tool 60 to something less than the total area of the embossing plate openings 21a and 21b. In this example, the design is a continuous border with decorative corners. To this end, the tool guide openings 31a and 31b for both corner and edge designs, permit the user to emboss the edges of the designs but stop before the ends of their respective openings 21a and 21b in the embossing plate. This embosses the edges of the design, but leaves the ends so they can be continued by the next segment of the design.

In practice, the four corners would first be embossed as shown in FIG. 16, with template 10 positioned at each of the corners in positions A, B, C, and D. Each edge would then be embossed, as shown in FIG. 17, with the edge portion of template 10 aligned to an edge with the tool guide openings 31a and 31b, slightly overlapping corner design 51 previously embossed, as shown at position A. The edges of the design are embossed, and because the areas across the ends of the corner design and edge design were not embossed, the individually embossed designs will meet to form a continuous, seamless design. Template 10 is moved to additional positions, B, C, D, and so forth, as necessary, to complete the edge design to the next corner. Each position slightly overlaps the previous one, forming a continuous, seamless design. For clarity, the outline of the template at position C is not shown. This process is repeated for the other three sides of sheet medium 50 to complete the design depicted in FIG. 11.

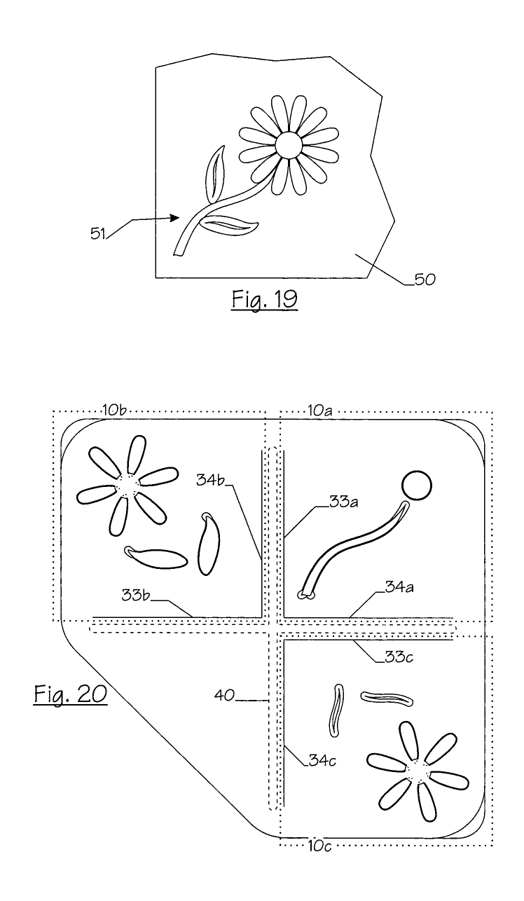

Another embodiment of the current invention, intended for embossing complex designs as illustrated in FIG. 19, is shown in FIG. 20. This provides for the use of more than one set of embossing openings 21 and tool guides 31 for creating a single design 51, permitting designs to be embossed that have elements spaced too closely together for a single template 10 such as the flower petals in the sample design, or that have elements within other elements, such as the veins within the leaves in the sample design.

This embodiment comprises similar elements as the previous embodiments, but the openings in the embossing plate and tool guide are grouped into sets as shown in FIG. 20. The sets are designated on the drawing as areas 10a, 10b, and 10c. In the example embodiment each set has it own first and second edge guides: 33a and 34a for openings set 10a, 33b and 34b for openings set 10b, and 33c and 34c for openings set 10c. Template 10 may have more or fewer sets than the example, and the sets may be arranged in any position on the template that best suites the design of the design and the number of sets required to create it.

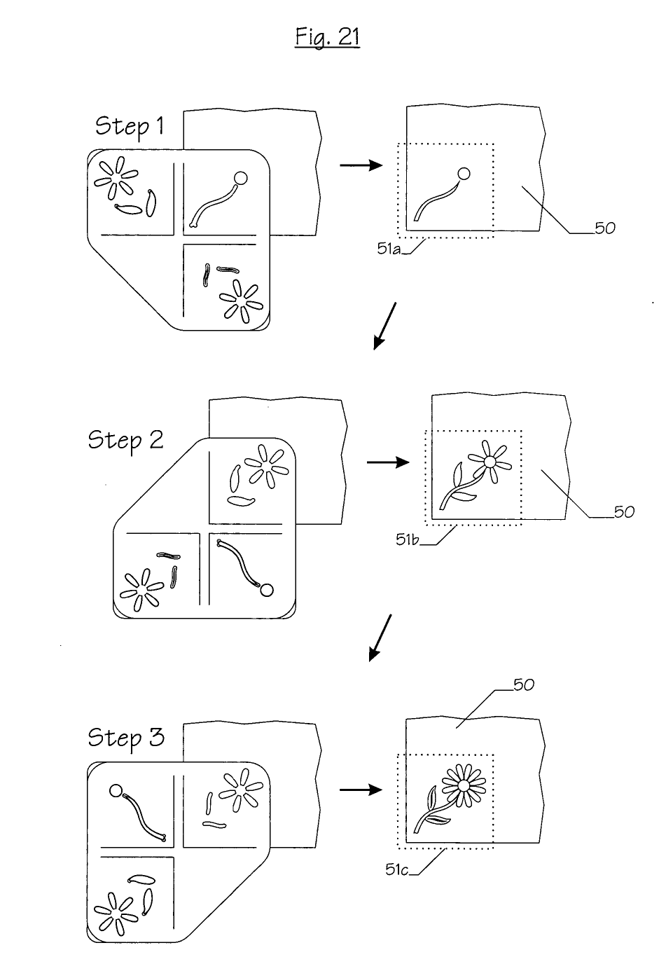

FIG. 21 shows how the example template from FIG. 20 would be used to create design 51 shown in FIG. 19. In Step 1, a corner of sheet medium 50 is inserted into one section of template 10, and the openings in that section are embossed. In the example, this embosses the flower stem and flower center. In Step 2, template 10 is repositioned so that a different set of openings is positioned over the corner embossed in Step 1, and the design from those openings is added to those embossed in Step 1. In the example, this embosses half of the flower petals and the leaves. In Step 3, template 10 is repositioned again so the last set of openings is positioned over the same corner embossed in Steps 1 and 2, and the remaining openings are embossed. In the example, this embosses the remaining flower petals and the veins within the leaves. This process may then be repeated for the other corners of the sheet medium.

Another embodiment of the current invention is intended for embossing designs in conjunction with various paper punches such as those commonly known as craft punches, corner punches, corner rounders and photo mounting punches. These punches produce decorative or functional holes or slits in a sheet medium such as paper or card stock, or cut a decorative or functional shape around the corner of or along an edge of a sheet medium.

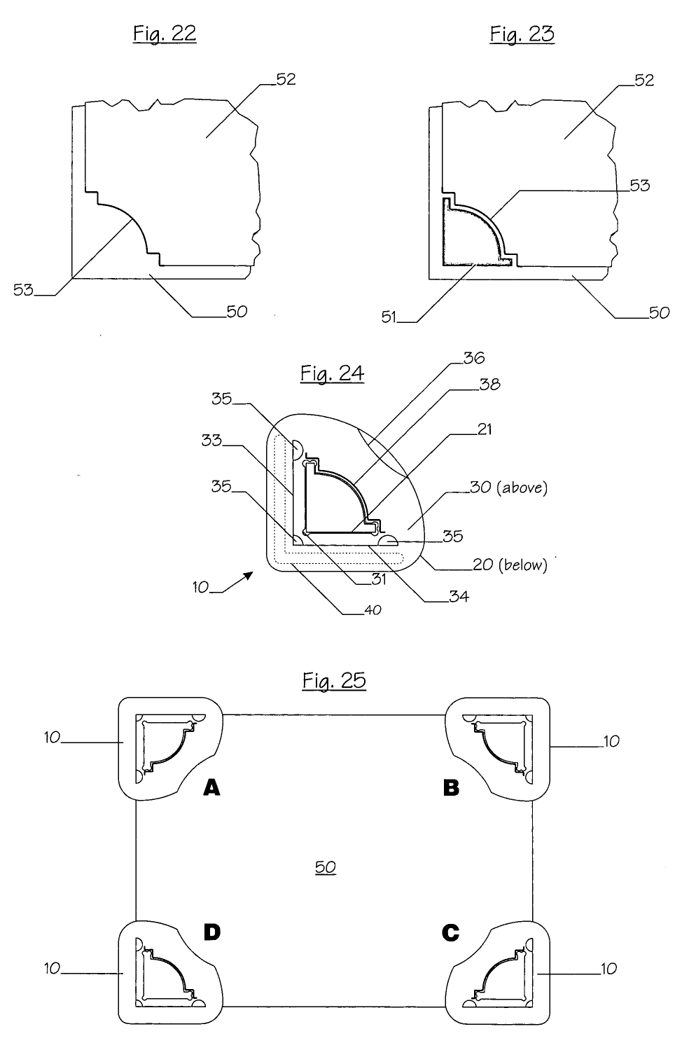

FIG. 22 illustrates one example of a mounting slit 53 created by a photo mounting punch. The mounting slit 53 is shown punched in one corner of a sheet medium 50. The corners of a photograph or other insert media 52 that is to be affixed to sheet medium 50 are inserted into slits 53. FIG. 23 illustrates how the addition of an embossed design created by this embodiment of the current invention can enhance the esthetics of the work.

Referring now to FIG. 24, template 10 comprises the same elements identified in the embodiment illustrated in FIGS. 2-6, with the addition of indicia 38 identifying the design and location of mounting slit 53 produced by the punch with which template 10 is used.

Referring now to FIG. 25, template 10 is positioned at each of the corners of sheet medium 50 at positions A, B, C, and D, and the design is embossed. Mounting slits 53 are then punched. For certain designs, holes or slits 53 may be punched first and the design embossed afterward. If the embossing is to be done relative to holes that are not located at the corners of sheet medium 50, it may be desirable to punch the holes first and align embossing template 10 to the holes.

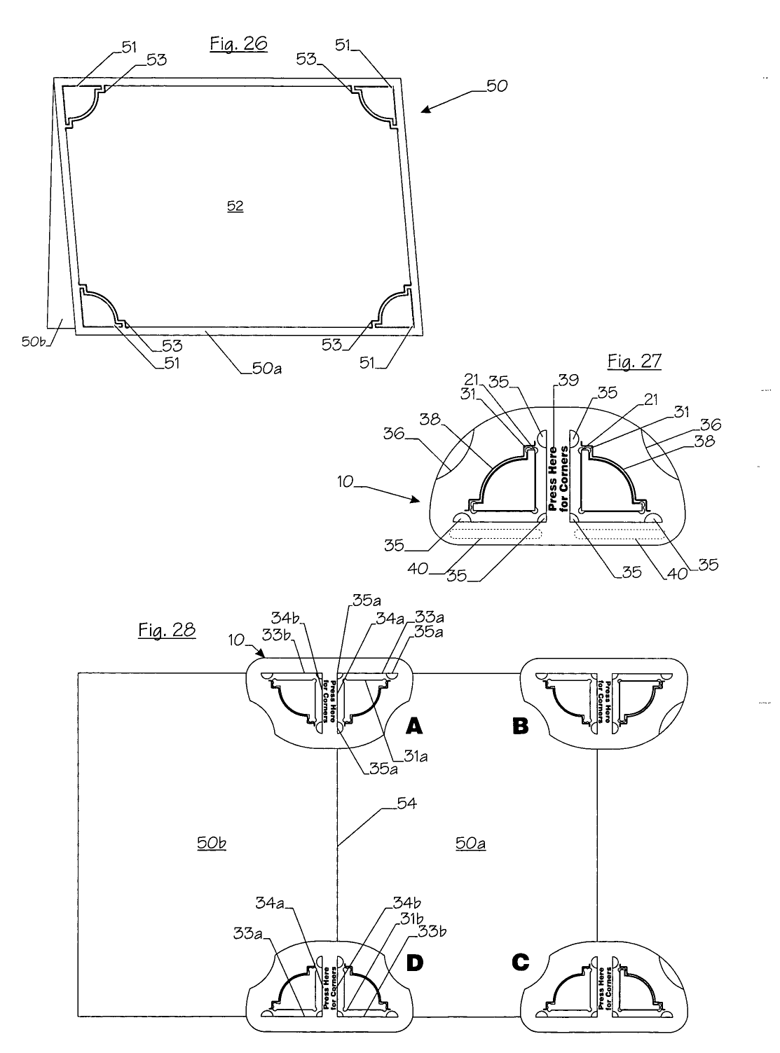

Another embodiment of the invention, intended to emboss designs in combination with photo mounting punches in the corners of one face of a folded notecard, as illustrated in FIG. 26, is shown in FIG. 27. In this application, mounting slits 53 are punched in the corners of and embossed designs 51 applied to only one face 50a of the folded notecard. The other face 50b is not punched or embossed.

Referring now to FIG. 27, the template contains two sets of openings such that the template can be used on the edge of the folded notecard in two different orientations to emboss the designs at the corners of the face of the card adjacent to the fold. The bonding areas 40a and 40b forming fixed edge guides 33a and 33b is limited to the edge of the template so second edge guides 34a and 34b may slide over the sheet medium for use along the edges of the folded notecard for the embossing the designs at the corners adjacent to the fold.

Referring now to FIG. 28, template 10 is used at position A to emboss one of the corners adjacent to the fold. Template 10 is disposed on the edge of the card such that the edge of the card aligns to edge guides 33a and 33b and the fold of the card aligns with second edge guide 34a as verified by observing the fold through edge alignment opening 35. The design is then embossed. Template 10 is removed from the folded notecard, is rotated 180°, and is disposed on the opposite edge at position D, aligning second edge guide 34b to the fold in the card and using the second set of openings to emboss the design in the second corner adjacent to the fold. Either set of edge guides 33a and 33b and openings 31a and 31b may be used to emboss the corners that are not adjacent to the fold at positions B and C. Then disposing the template on those corners, the user presses the top surface of template 10 at the area indicated by indicia 39 to hold that area of the tool guide layer against the embossing plate, thereby providing second edge guide 34a or 34b against which the corners of the card align.

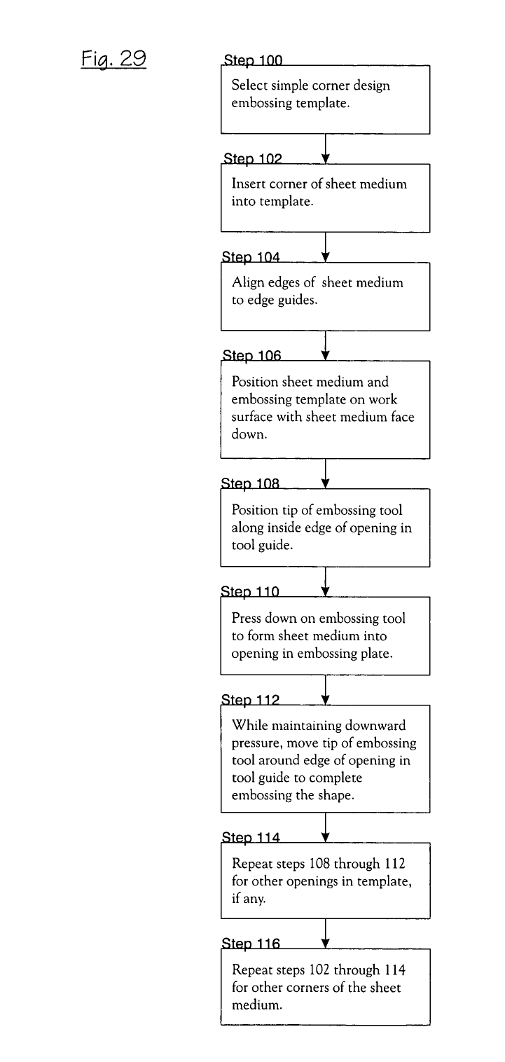

Flow chart FIG. 29 illustrates the process for embossing corner design 51 shown in FIG. 1, as produced by the template shown in FIGS. 2 through 6:

In step 100, the user selects template 10 for the design to be embossed into the corner of sheet medium 50. In step 102, the user inserts sheet medium 50 with its face (the side on which the embossed design will be raised) downward between embossing plate 30 and tool guide 20 of embossing template 10. Insertion area 36 provides a difference in the positions of the edges for tool guide 30 and embossing plates 20 to facilitate the insertion of sheet medium 50.

Next, in step 104, the user moves sheet medium 50 fully into embossing template 10 until the edges of the sheet medium, adjacent to the corner to be embossed, contact and align with first and second edge guides 33 and 34. The user examines the position of the edges of sheet medium 50 through edge alignment openings 35 to verify that sheet medium 50 is fully seated against both edge guides. In step 106, the user holds the template in position on the corner of sheet medium 50 and places it and sheet medium 50, which is still face down, on a working surface 70, as shown in FIGS. 8 and 9.

In step 108, as shown in FIG. 6, the user positions tip 62 of embossing tool 60 inside an edge of the opening of tool guide 30. In step 110, the user presses down on the embossing tool to form sheet medium 50 into the corresponding opening in embossing plate 20. In step 112, as shown in FIG. 6, the user continues to press down on embossing tool 60 and moves it around inside edge 31 of the opening in tool guide 30, causing sheet medium 50 to be pressed into opening 21 in embossing plate 20 and forming embossed design 51 in sheet medium 50.

Next, in step 114, the actions from steps 108 through 112 are repeated for all other openings in the design, if any. If the design has only a single opening as shown in the example design, this step is skipped. In step 116, template 10 is positioned on each of the remaining corners and steps 102 through 114 are repeated to emboss design 51 thereon.

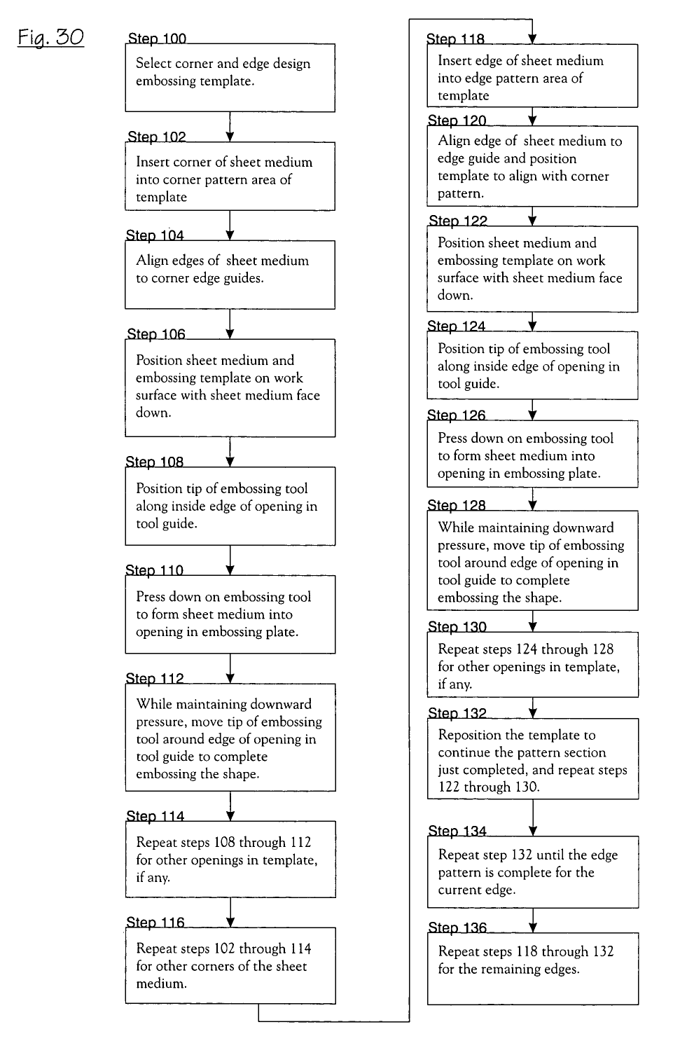

In another embodiment of the present invention, flow chart FIG. 30 illustrates the process for embossing the combined corner and edge design shown in FIG. 10, as produced by template 10 shown in FIGS. 11 through 18. In step 100, the user selects template 10 for the design to be embossed into the corner of sheet medium 50. In step 102, the user inserts sheet medium 50 with its face (the side on which the embossed design will be raised) downward into the area of the template containing the corner design, inserting sheet medium 50 between embossing plate 30 and tool guide 20 of embossing template 10. The insertion area 36a provides a difference in the positions of the edges for tool guide 30 and embossing plates 20 to facilitate the insertion of sheet medium 50 by providing a surface on embossing plate 20 that can be pressed away from tool guide 30, opening a gap between them for easier insertion of sheet medium 50.

Next, in step 104, the user moves sheet medium 50 fully into the corner design area of embossing template 10 until the edges of sheet medium 50, adjacent to the corner to be embossed, contact and align with first and second edge guides 33a and 34a. The user examines the position of the edges of sheet medium 50 through edge alignment openings 35a to verify that sheet medium 50 is fully seated against both edge guides 33 and 34.

In step 106, the user holds template 10 in position on the corner of sheet medium 50 and places it and sheet medium 50, which is still face down, on a working surface. In step 108, as shown in FIG. 15, the user positions tip 62 of embossing tool 60 inside one of the openings 31 in tool guide 30. In step 110, the user presses down on the embossing tool to form the sheet medium into the corresponding opening in the embossing plate.

In step 112, as shown in FIG. 6, the user continues to press down on embossing tool 60 and moves it along opening 31 in tool guide 30 following tool path 61, causing sheet medium 50 to be pressed into opening 21 in embossing plate 20 and forming embossed design 51 in sheet medium 50. In step 114, the actions from steps 108 through 112 are repeated for the other opening in the design, if any.

Next, in step 116, the template is positioned on each of the remaining corners and steps 102 through 114 are repeated to emboss the design thereon. In step 118, template 10 is positioned such that sheet medium 50 is inserted into the portion of template 10 containing the edge design, again using the insertion area to facilitate the insertion. In step 120, the edge of sheet medium 50 is positioned against edge guide 33 and with openings 31 in tool guide 30 slightly overlapping an embossed corner design as shown at position A in FIG. 18.

In step 122, the user holds template 10 in position on the edge of sheet medium 50 and places it and sheet medium 50, which is still face down, on a working surface. In step 124, as shown in FIG. 16, the user positions tip 62 of embossing tool 60 inside one of openings 31 in tool guide 30. In step 126, the user presses down on embossing tool 60 to form sheet medium 50 into the corresponding opening 21 in embossing plate 20.

Next, in step 128, as shown in FIG. 16, the user continues to press down on embossing tool 60 and moves it along opening 31 in tool guide 30 following tool path 61, causing sheet medium 50 to be pressed into opening 21 in embossing plate 20 and forming half of the embossed edge design at that position on sheet medium 50. In step 130, the actions from steps 124 through 128 are repeated for the other opening in the design, forming the other half of the edge design at that position on sheet medium 50. Because the edge design slightly overlaps the corner design and only the sides of the designs are embossed, not the ends, the corner and edge designs combine to form one continuous embossed design 51 with no noticeable seam.

In step 132, template 10 is moved along the edge of sheet medium 50 to the position identified as B in FIG. 18, and steps 122 through 130 are repeated to emboss the next portion of the design. Because the edge design slightly overlaps the previously embossed edge design and only the sides of the designs are embossed, not the ends, the edge designs combine to form one continuous embossed design 51 with no noticeable seam. In step 134, step 132 is repeated at the remaining positions along the edge as identified as positions C and D in FIG. 18, completing the embossing of the edge design for one edge. Lastly, in step 136, steps 118 through 134 are repeated for the remaining edges of sheet medium 50, completing design 51 shown in FIG. 11.

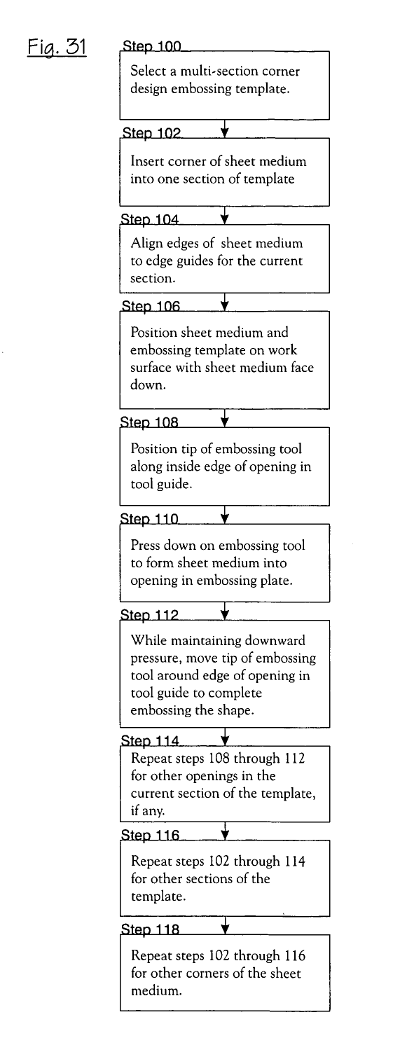

In one embodiment of the present invention, as illustrated in flow chart FIG. 31, a process is described for embossing the complex corner design shown in FIG. 19, as produced by template 10 shown in FIGS. 20 and 21, which uses three sets of openings. In step 100, the user selects template 10 for the design to be embossed into the corner of sheet medium 50. In step 102, the user inserts sheet medium 50 with its face (the side on which the embossed design will be raised) downward between embossing plate 30 and tool guide 20 in one section 10a of embossing template 10.

Next, in step 104, the user moves sheet medium 50 fully into section 10a of embossing template 10 until the edges of sheet medium 50, adjacent to the corner to be embossed, contact and align with first and second edge guides 33a and 34a. In step 106, the user holds template 10 in position on the corner of sheet medium 50 and places it and sheet medium 50, which is still face down, on a working surface. In step 108, the user positions tip 62 of embossing tool 60 inside an edge of opening 31 of tool guide 30.

In step 110, the user presses down on embossing tool 60 to form sheet medium 50 into the corresponding opening 21 in embossing plate 20. In step 112, the user continues to press down on embossing tool 60 and moves it around the inside edge of opening 31 in tool guide 30, causing sheet medium 50 to be pressed into opening 21 in embossing plate 20 and forming embossed design 51 in sheet medium 50. In step 114, the actions from steps 108 through 112 are repeated for all other openings in the current section of the design. In step 116, the actions from steps 102 through 114 are repeated on the same corner of sheet medium 50 for the other sections of template 10 to emboss the remaining elements of the design at that corner. In step 118, steps 102 through 116 are repeated to emboss the design on each of the remaining corners.

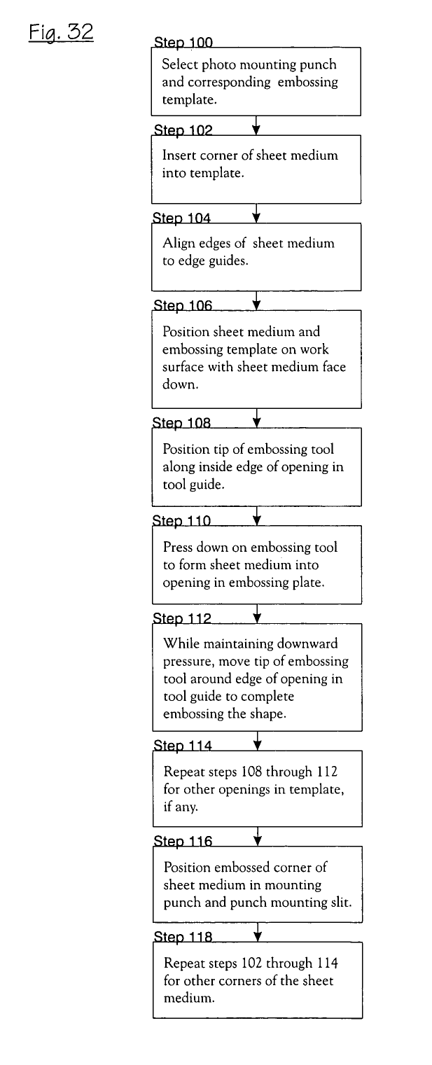

In one embodiment of the present invention, as illustrated in flow chart FIG. 32, a process is described for embossing the photo mount corner design shown in FIG. 23, as produced by the template shown in FIGS. 24 and 25. In step 100, the user selects template 10 and corresponding photo mounting punch for the design to be embossed and punched into the corners of sheet medium 50.

Next, in step 102, the user inserts sheet medium 50 with its face (the side on which the embossed design will be raised) downward between embossing plate 30 and tool guide 20 of embossing template 10. In step 104, the user moves sheet medium 50 fully into embossing template 10 until the edges of sheet medium 50, adjacent to the corner to be embossed, contact and align with first and second edge guides 33 and 34. The user examines the position of the edges of sheet medium 50 through edge alignment openings 35 to verify that sheet medium 50 is fully seated against both edge guides 33 and 34. In step 106, the user holds template 10 in position on the corner of sheet medium 50 and places it and sheet medium 50, which is still face down, on a working surface.

Next, in step 108, the user positions tip 62 of embossing tool 60 inside an edge of opening 31 of tool guide 30. In step 110, the user presses down on embossing tool 60 to form sheet medium 50 into the corresponding opening 21 in embossing plate 20. In step 112, the user continues to press down on embossing tool 60 and moves it around the inside edge of opening 31 in tool guide 30, causing sheet medium 50 to be pressed into opening 21 in embossing plate 20 and forming embossed design 51 in sheet medium 50.

In step 114, the actions from steps 108 through 112 are repeated for all other openings in the design, if any. If the design has only a single opening as shown in the example design, this step is skipped. In step 116, the photo mount punch corresponding to the embossed design is positioned at the embossed corner of sheet medium 50 and a mounting slit is punched. In step 118, steps 102 through 116 are repeated for each of the remaining corners of sheet medium 50 to emboss design 51 thereon and punch the mounting slit.

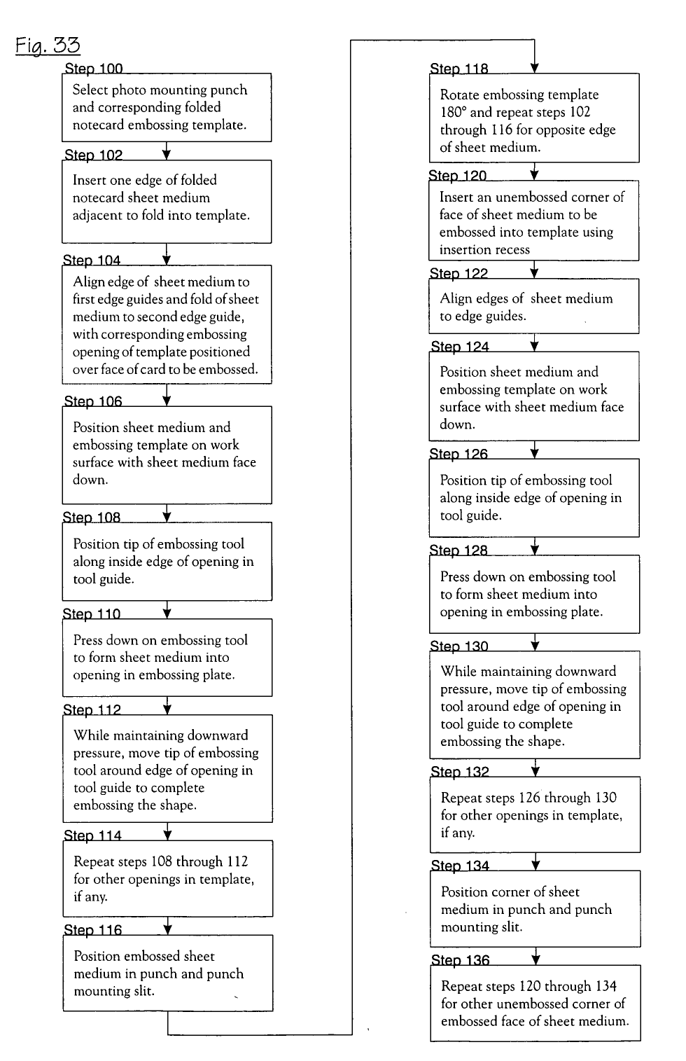

In one embodiment of the present invention as illustrated in flow chart FIG. 33, a process is described for embossing the photo mount corner design for use on folded notecards shown in FIG. 26, as produced by template 10, shown in FIGS. 27 and 28. In step 100, the user selects template 10 and corresponding photo mounting punch for the design to be embossed and punched into the corners of one face 50a of sheet medium 50.

Next, in step 102, the user inserts an edge of the face 50a to be embossed of sheet medium 50 with its face (the side on which the embossed design will be raised) downward between embossing plate 30 and tool guide 20 of embossing template 10. In step 104, the user moves sheet medium 50 fully into embossing template 10 until the edges of sheet medium 50, adjacent to the corner to be embossed, contact first edge guides 33a and 33b. The template is slideably positioned along the edge of the folded notecard until tool guide opening 31a is positioned over the face 50a to be embossed and punched, and second edge guide 34a aligns with fold 54 in folded notecard 50. The user examines the position of the fold and edge of folded notecard 50 through edge alignment openings 35a to verify that template 10 is properly positioned.

In step 106, the user holds template 10 in position on the corner of sheet medium 50 and places it and sheet medium 50, which is still face down, on a working surface. In step 108, the user positions tip 62 of embossing tool 60 inside the edge of opening 31a of tool guide 30, corresponding to the face of folded notecard 50 to be embossed. In step 110, the user presses down on embossing tool 60 to form sheet medium 50 into the corresponding opening 21 in embossing plate 20.

Next, in step 112, the user continues to press down on embossing tool 60 and moves it around the inside edge of opening 31 in tool guide 30, causing sheet medium 50 to be pressed into opening 21 in embossing plate 20 and forming embossed design 51 in sheet medium 50. In step 114, the actions from steps 108 through 112 are repeated for all other openings in the design for the current face of folded notecard 50, if any. If the design has only a single opening as shown in the example design, this step is skipped.

In step 116, the photo mount punch corresponding to the embossed design is positioned at the embossed corner of sheet medium 50 and a mounting slit is punched. In step 118, the template is rotated 180° and disposed on the opposite edge of folded notecard 50, and steps 102 through 116 are repeated using edge guides 33a, 33b and 34b, edge alignment openings 35b, and tool guide opening 31b to emboss and punch the opposite corner adjacent to the fold.

Next, in step 120, the user inserts the one of the unembossed corners of face 50a of folded notecard 50 being embossed with its face (the side on which the embossed design will be raised) downward into either corner design of embossing template 10 between embossing plate 30 and tool guide 20. In step 122, the user moves sheet medium 50 fully into embossing template 10 until the edges of sheet medium 50, adjacent to the corner to be embossed, contact and align with first and second edge guides 33 and 34. The user examines the position of the edges of sheet medium 50 through the edge alignment openings to verify that sheet medium 50 is fully seated against both edge guides 33 and 34.

In step 124, the user holds template 10 in position on the corner of sheet medium 50 and places it and sheet medium 50, which is still face down, on a working surface. In step 126, the user positions tip 62 of embossing tool 60 inside an edge of opening 31 of tool guide 30. In step 128, the user presses down on embossing tool 60 to form sheet medium 50 into the corresponding opening 21 in embossing plate 20.

Next, in step 130, the user continues to press down on embossing tool 60 and moves it around the inside edge of opening 31 in tool guide 30, causing sheet medium 50 to be pressed into opening 21 in embossing plate 20 and forming embossed design 51 in sheet medium 50.

In step 132, the actions from steps 126 through 130 are repeated for all other openings in the design, if any. If the design has only a single opening as shown in the example design, this step is skipped. In step 134, the photo mount punch corresponding to the embossed design is positioned at the embossed corner of sheet medium 50 and a mounting slit is punched. In step 136, the actions of steps 120 through 134 are repeated for the remaining corner of the face of folded notecard 50 being embossed and punched.

Many and diverse embossed designs are possible using this invention. It is not to be construed that they are limited to designs like or similar to those shown herein. While only certain features of the invention have been illustrated and described herein, many modifications, substitutions, changes or equivalents will now occur to those skilled in the art. It is therefore to be understood that this application is intended to cover all such modifications and changes that fall within the true spirit of the invention.

What is claimed is:

What is claimed is:

1. An embossing template for embossing design onto a sheet media using an embossing tool, said template comprising:
an embossing plate, said embossing plate having at least one embossing opening theron;
a tool guide coupled to said embossing plate, said tool guide having at least one tool guide opening thereon, said tool guide opening corresponding to said embossing opening, such such that when said sheet media is inserted between said embossing plate and said tool guide, said embossing tool is moved around the edges of said tool guide opening, pressing said sheet media against the edges of said embossing opening, embossing a design into said sheet media.

2. The embossing template as claimed in claim 1, wherein, said tool guide further comprises at least one edge guide to ensure said sheet media is properly inserted in said template.

3. The embossing template as claimed in claim 2, wherein said tool guide further comprises at least one edge alignment opening along said edge guide to allow a user to visually verify said sheet media is properly aligned within said template.

4. The embossing template as claimed in claim 2, wherein said template comprises at least two edge guides, configured to allow a portion of said tool guide to partially fold upward, away from said embossing plate so as to easy positioning of said sheet media within said template.

5. The embossing template as claimed in claim 1, wherein said embossing opening in said embossing plate is smaller than said tool guide opening in said tool guide, such that said distance between their edges forms an opening offset.

6. The embossing template as claimed in claim 5, wherein the tip of said embossing tool is rounded.

7. The embossing template as claimed in claim 6, wherein said opening offset is smaller when said embossing tool tip is smaller than said embossing opening in said embossing plate, such that said rounded tip of said embossing tool can engage said sheet media thoroughly against the edge of said embossing opening, forming a sharper embossed image.

8. The embossing template as claimed in claim 6, wherein said opening offset is larger when said embossing tool tip is lager than said embossing opening in said embossing plate, such that said rounded tip of said embossing tool is able to pass significantly through said tool guide opening to engage said sheet media thoroughly against the edge of said embossing opening.

9. The embossing template as claimed in claim 1, wherein said embossing opening on said embossing plate and said tool guide opening on said tool guide are configured to emboss an image in the corner of said sheet media.

10. The embossing template as claimed in claim 1, wherein said embossing opening on said embossing plate and said tool guide opening on said tool guide are configured to emboss an image along an edge of said sheet media.

11. The embossing template as claimed in claim 1, wherein said embossing plate maintains a plurality of embossing openings, and said tool guid maintains a plurality of corresponding tool guide openings.

12. The embossing template as claimed in claim 11, wherein said plurality of embossing openings, each form a different embossed image.

13. The embossing template as claimed in claim 12, wherein said plurality of embossing openings, each forming a different embossed image, when combined form a single larger embossed image.

14. The embossing template as claimed in claim 1, wherein said image, embossed on said sheet media, is configured to correspond to a hole or wlit punched in said sheet media by a corresponding punch tool.
